(19) United States
(12) Patent Application Publication
(10) Pub. No.: US 2024/0001475 A1
(43) Pub. Date: Jan. 4, 2024

(54) WELDING-WIRE-STRAIGHTENING APPARATUS

(71) Applicant: Kabushiki Kaisha Kobe Seiko Sho (Kobe Steel, Ltd.), Kobe-shi (JP)

(72) Inventors: Kenta SUGIZAKI, Fujisawa-shi (JP); Yu UMEHARA, Fujisawa-shi (JP)

(73) Assignee: Kabushiki Kaisha Kobe Seiko Sho (Kobe Steel, Ltd.), Kobe-shi (JP)

(21) Appl. No.: 18/330,773

(22) Filed: Jun. 7, 2023

(30) Foreign Application Priority Data
Jun. 29, 2022 (JP) 2022-104876

(51) Int. Cl. B23K 9/133

(52) U.S. Cl. CPC B23K 9/1336

(57) ABSTRACT

In each of roller groups, multiple straightening rollers include a first roller, a second roller, . . . , an n-th roller in this order in a direction in which a welding wire passes through, and the n rollers (n is an integer of 4 or more) bend the welding wire alternately in opposite directions and straighten a curl of the welding wire. The n rollers are arranged such that an entrance wire deformation amount εᵢₙ calculated by using a numerical formula of εᵢₙ={2t(δᵢₙ+t)/ Lᵢₙ²}×100 ranges from 0.6 to 1.0 (%), and an exit wire deformation amount tout calculated by using a numerical formula of εₒᵤₜ=2t(δₒᵤₜ+t)/Lₒᵤₜ²}×100 ranges from 0.0 to 0.3 (%) . Diameters 2r of the multiple straightening rollers are 20 mm or less. An arrangement interval L of the multiple straightening rollers is 11.5 mm or more.

### BACKGROUND OF THE INVENTION

### 1. Field of the Invention

The present invention relates to a welding-wire-straightening apparatus.

### 2. Description of the Related Art

In metal welding such as arc welding, a welding wire that is fed to a welding torch is melted by using arc heat and is consumed. Accordingly, the welding wire needs to be continuously fed to the welding torch depending on the consumption of the welding torch.

The welding wire that is wound around a spool or that is contained in a pack is pulled out and is fed to the welding torch. The pulled welding wire has a curl and bents or twists. If the welding wire that has the curl is fed to the welding torch as it is, then the accuracy of a position at which an end portion of the wire is aimed (referred to below as targetability) is reduced. Accordingly, in the existing cases, the welding wire that has the curl (simply referred to below as the wire in some cases) is straightened by a welding-wire-straightening apparatus (simply referred to below as a straightening apparatus in some cases) and is subsequently fed to the welding torch in order to obtain good targetability during welding.

As for a welding-wire-straightening apparatus disclosed in Japanese Patent No. 3578586, a predetermined number of straightening rollers are fixed at predetermined positions such that an entrance wire deformation amount and an exit wire deformation amount are within defined ranges in order to prevent wire misalignment from occurring and prevents the quality of welding from being reduced.

The straightening apparatus may be disposed at a position on a robot arm of a welding robot, may be disposed at the position of the welding wire right after the welding wire is pulled out from the pack, or may be disposed at a position between the pack and the welding robot. However, if the wire is fed a long distance after the wire passes through the straightening apparatus, then the wire bends or twists again, and accordingly, a position at which the wire is straightened is preferably near an arc point in order to improve the targetability of the wire. Accordingly, the straightening apparatus is preferably disposed at a position right before a feeding device, such as a position on the robot arm. Regardless of the position at which the straightening apparatus is installed, the size of the straightening apparatus is preferably small so as not to be restricted due to the size or shape of a space for installation. In particular, in the case where the straightening apparatus is disposed on the robot arm, the size of the straightening apparatus is preferably small such that the range of movement of the welding robot is not restricted.

In Japanese Patent No. 3578586, however, the position at which the straightening apparatus is installed and a decrease in the size of the straightening apparatus are not described in detail, and there is a room for improvement.

As for a welding-wire-straightening apparatus disclosed in Japanese Patent No. 6109064, the diameters of multiple straightening rollers are 20 mm or less, which is a small value that is not used for existing straightening apparatuses. The diameters of the straightening rollers are thus small, and the size of the straightening apparatus can consequently decrease.

### SUMMARY OF THE INVENTION

The present inventors have found that the targetability is degraded, particularly, when a flux containing wire that contains flux inside an outer skin (referred to below as a flux containing wire) is used in the case where the diameters of straightening rollers are small as in Japanese Patent No. 6109064.

The present invention has been accomplished in view of the problems described above, and it is an object of the present invention to provide a welding-wire-straightening apparatus that can improve the targetability of a wire, particularly, the targetability of a flux containing wire.

The object of the present invention described above is achieved by using a structure [1] described below regarding a welding-wire-straightening apparatus.
[1] A welding-wire-straightening apparatus includes two sets of roller groups each of which includes multiple straightening rollers. A welding wire that bends is straightened by causing the welding wire to pass through the two sets of roller groups. The multiple straightening rollers that are included in the two sets of roller groups are arranged at a predetermined arrangement interval L in a direction in which the welding wire passes through such that a straightening path through which the welding wire passes is interposed therebetween. The two sets of roller groups are arranged such that directions in which the straightening path is interposed differ from each other. In each of the two sets of roller groups, the multiple straightening rollers include a first roller, a second roller, an n-th roller in this order in the direction in which the welding wire passes through, and the n rollers (n is an integer of 4 or more) bend the welding wire alternately in opposite directions and straighten a curl of the welding wire. The n rollers of the multiple straightening rollers are arranged such that an entrance wire deformation amount εᵢₙ that is calculated by using a numerical formula of εᵢₙ={2t(δᵢₙ+t)/Lᵢₙ²}×100 ranges from 0.6 to 1.0 (%), and an exit wire deformation amount εₒᵤₜ that is calculated by using a numerical formula of εₒᵤₜ=2t(δₒᵤₜ+t)/Lₒᵤₜ²}×100 ranges from 0.0 to 0.3 (%), where t (mm) is a diameter of the welding wire, εᵢₙ (%) is the entrance wire deformation amount due to the first roller, the second roller, and a third roller, δᵢₙ (mm) is an entrance roller engaging amount, 2Lᵢₙ (mm) is a distance between axes of the first roller and the third roller, εₒᵤₜ (%) is the exit wire deformation amount due to a (n−2)-th roller, a (n−1)-th roller, and the n-th roller, δₒᵤₜ (mm) is an exit roller engaging amount, and 2Lₒᵤₜ (mm) is a distance between axes of the n-th roller and the (n−2)-th roller. Diameters 2r of the multiple straightening rollers are 20 mm or less. The arrangement interval L of the multiple straightening rollers is 11.5 mm or more.

### BRIEF DESCRIPTION OF THE DRAWINGS

FIG. 1 schematically illustrates a welding wire that is pulled out from a pack, that passes through a welding-wire-straightening apparatus according to the present embodiment, and that is fed to a welding torch of a welding robot;

FIG. 2A is a front view of the straightening apparatus;

FIG. 2B is a top view of the straightening apparatus.

FIG. 3A is a front view of a straightening roller;

FIG. 3B is a top view of the straightening roller;

FIG. 4 illustrates the welding wire that passes through the straightening apparatus illustrated in FIG. 2A viewed in front of the straightening apparatus;

FIG. 5 is an enlarged view of a first roller group of the straightening apparatus;

FIG. 6 illustrates the concept of a relationship between a depth at which the welding wire is pushed and the arrangement of straightening rollers in the first roller group and in a second roller group;

FIG. 7A illustrates the concept of a relationship between the straightening rollers and the welding wire in the case where the diameters of the straightening rollers are relatively large;

FIG. 7B illustrates the concept of a relationship between the straightening rollers and the welding wire in the case where the diameters of the straightening rollers are smaller than those in FIG. 7A;

FIG. 8A illustrates the concept of a relationship between the straightening rollers and the welding wire in the case where the arrangement intervals of the straightening rollers are longer than those in FIG. 7A;

FIG. 8B illustrates the concept of a relationship between the straightening rollers and the welding wire in the case where the arrangement intervals of the straightening rollers are shorter than those in FIG. 8A;

FIG. 9 schematically illustrates a targetability test apparatus;

FIG. 10 illustrates the results of tests in first to fourth examples; and

FIG. 11 illustrates the results of tests in first to fourth comparative examples.

### DESCRIPTION OF THE PREFERRED EMBODIMENTS

A welding-wire-straightening apparatus according to an embodiment of the present invention will hereinafter be described in detail with reference to the drawings. The embodiment described below is a specific example of the present invention, and components according to the present invention are not limited to those in the specific example. Accordingly, the technical range of the present invention is not limited to that disclosed according to the present embodiment.

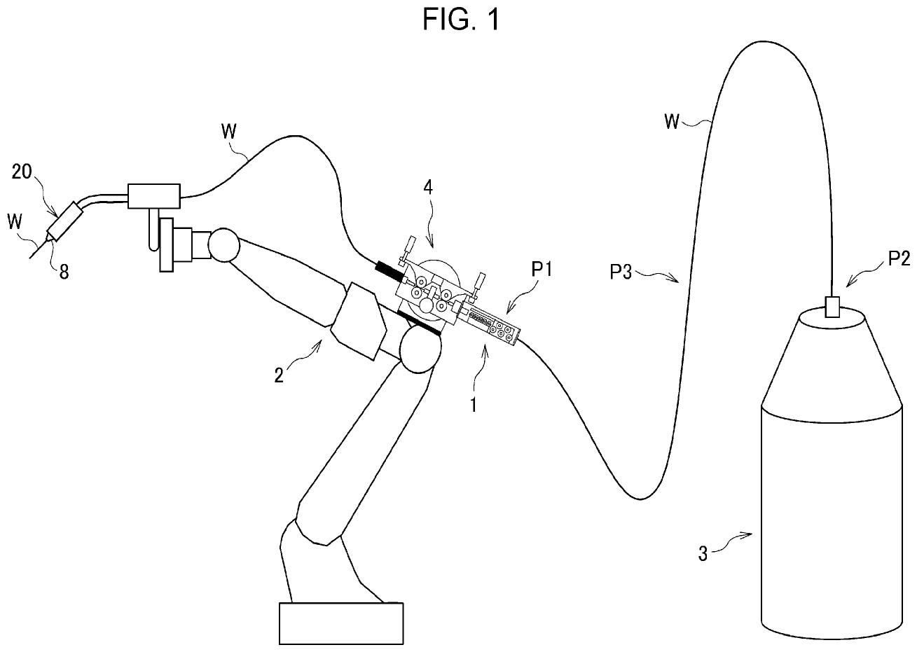

A process of straightening a welding wire W that is fed to a welding torch 20 will be described with reference to FIG. 1, and a welding-wire-straightening apparatus 1 according to an embodiment of the present invention will be subsequently described. FIG. 1 schematically illustrates the welding wire W that is pulled out from a pack 3, that passes through the welding-wire-straightening apparatus 1 according to the present embodiment, and that is fed to the welding torch 20 of a welding robot 2.

Referring to FIG. 1, for example, the welding wire W is contained in the pack 3 with the welding wire W wound into a ring shape and is pulled out from an upper end of the pack 3.

The present inventors have diligently researched, have found that a flux containing wire has hardness, rigidity, and tensile strength that differ from those of a solid wire and is likely to deform, that the flux containing wire deforms due to a local load that is applied thereto in the case where a straightening roller having a small diameter is used for a welding-wire-straightening apparatus, and that targetability is degraded, and have conceived the welding-wire-straightening apparatus according to the present invention.

The welding wire W can be a flux containing wire. The use of the welding-wire-straightening apparatus 1 according to the present invention for a solid wire that is likely to deform as in a flux containing wire enables the targetability to be improved.

The welding wire W that is pulled out from the pack 3 is fed to, for example, the welding torch 20 that is disposed at an end of an arm of the welding robot 2 and passes through the welding-wire-straightening apparatus 1 according to the present embodiment before the welding torch 20.

The welding wire W passes through the welding-wire-straightening apparatus 1. Consequently, a curl or a twist that is caused by containing the welding wire W in the pack 3 is smoothed, and the welding wire W is substantially straightened without curling or twisting. The welding wire W that is straightened is fed to the welding torch 20 for, for example, arc welding by using a feeding device 4 and passes through an end of the welding torch 20.

At this time, if portions of the welding wire W curl or twist in various forms, then an end of the welding wire W shifts from a position at which the welding torch 20 is aimed depending on the degrees of the curls or the twists, that is, so-called “wire misalignment” occurs. As a result of the occurrence of the “wire misalignment”, the targetability of the wire is degraded, the welding wire W cannot be melted at a proper welding position, a welding failure such as a meandering bead or a lack of fusion occurs, and a good weld joint is not obtained. In view of this, the welding-wire-straightening apparatus 1 that straightens the welding wire W has a very important role in inhibiting wire misalignment from occurring and in improving the targetability.

In FIG. 1, the welding-wire-straightening apparatus 1 (referred to below as the straightening apparatus 1) is disposed at a position P1 on a robot arm of the welding robot 2 but may be disposed at a position P2 of the welding wire W right after the welding wire W is pulled out from the pack 3 or may be disposed at a position P3 between the pack 3 and the welding robot 2. However, the wire is preferably straightened near an arc point in order to improve the ability to feed the wire and the targetability of the wire due to a reduction in a load to feed the wire. Accordingly, the straightening apparatus 1 is more preferably disposed at the position P1 on the robot arm. Regardless of the position P1, P2, or P3 at which the straightening apparatus 1 is installed, the size of the straightening apparatus 1 is preferably small so as not to be restricted due to the size or shape of a space for installation. In particular, in the case where the straightening apparatus 1 is disposed at a position on the robot arm such as the position P1, the size of the straightening apparatus 1 is preferably especially small so as not to restrict the range of movement of the welding robot 2.

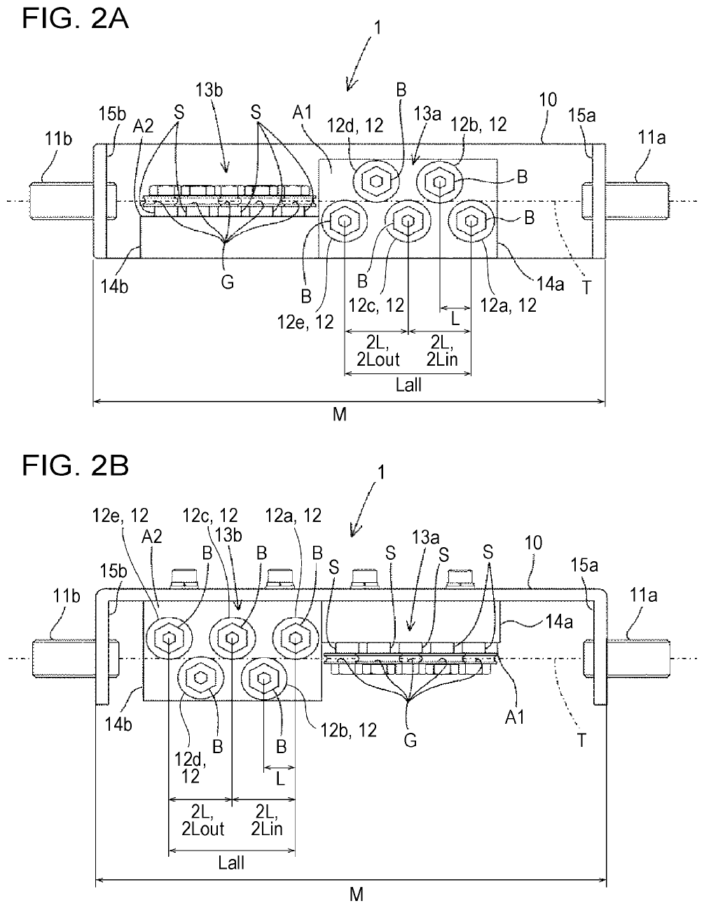

The structure of the straightening apparatus 1 will now be described with reference to FIG. 2A and FIG. 2B. FIG. 2A is a front view of the straightening apparatus 1. FIG. 2B is a top view of the straightening apparatus 1 illustrated in FIG. 2A viewed from above in front of the paper, that is, illustrates an upper surface of the straightening apparatus 1.

Referring to FIG. 2A, the straightening apparatus 1 includes a frame 10, two guide pipes (referred to below as guide bodies) 11a and 11b that are disposed at both ends of the frame 10, a first roller group 13a and a second roller group 13b corresponding to two sets of roller groups that include multiple straightening rollers 12, and a first base 14a and a second base 14b corresponding to two bases that support the first roller group 13a and the second roller group 13b and that are fixed to the frame 10. The straightening apparatus 1 straightens the welding wire W that bends by causing the welding wire W to pass through the first roller group 13a and the second roller group 13b.

The frame 10 is a plate member that has a rectangular flat surface and includes two wall plates 15a and 15b that are substantially perpendicular to the flat surface and that have substantially the same plate shape at both ends of the flat surface in a longitudinal direction. The two wall plates 15a and 15b are substantially perpendicular to a direction in which the flat surface extends, face each other, and are substantially parallel with each other.

The guide bodies 11a and 11b are tubes and are members that have through-holes that extend in the longitudinal direction of the tubes. The through-holes of the guide pipes 11a and 11b have sufficiently larger diameters than the diameter t of the welding wire W.

As illustrated in FIG. 2A, the guide bodies 11a and 11b extend through the wall plates 15a and 15b with the axial centers of the through-holes coinciding with each other and are held by the wall plates 15a and 15b. The guide body 11a is held by the wall plate 15a. The guide body 11b is held by the wall plate 15b.

The welding wire W that passes through the through-hole of the guide body 11a from a position outside the frame 10, for example, from the right of the paper in the FIG. 2A substantially linearly passes through a space inside the frame 10 toward the guide body 11b and exits toward a position outside the frame 10 via the through-hole of the guide body 11b. A path on which the welding wire W passes through the space inside the frame 10 at this time is a straight line that is illustrated by using one-dot chain lines in FIG. 2A and FIG. 2B and is referred to as a straightening path T.

Each of the first roller group 13a and the second roller group 13b includes five straightening rollers 12 described later. The five straightening rollers 12 face each other with the straightening path T interposed therebetween and are arranged at predetermined arrangement intervals L in a direction in which the welding wire W passes through. The structures of the straightening rollers 12 will be described in detail, and the structures of the first roller group 13a and the second roller group 13b will be subsequently described.

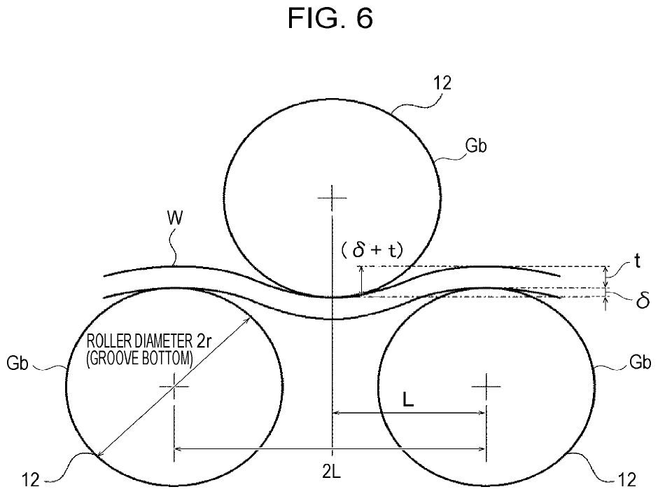

As illustrated in FIG. 6, each straightening roller 12 has a disk shape having a thickness greater than the diameter t of the welding wire W and is capable of rotating about the axial center of the disk shape. According to the present embodiment, the straightening roller 12 includes a bearing such as a rolling bearing that includes an inner race, an outer race, and balls. The straightening roller 12 is composed of, for example, stainless steel.

Accordingly, the straightening roller 12 includes a member that includes a bearing that includes an inner race, an outer race, and balls, and the thickness of the outer race in the direction of the axial center about which the straightening roller 12 rotates is greater than the diameter t of the welding wire W.

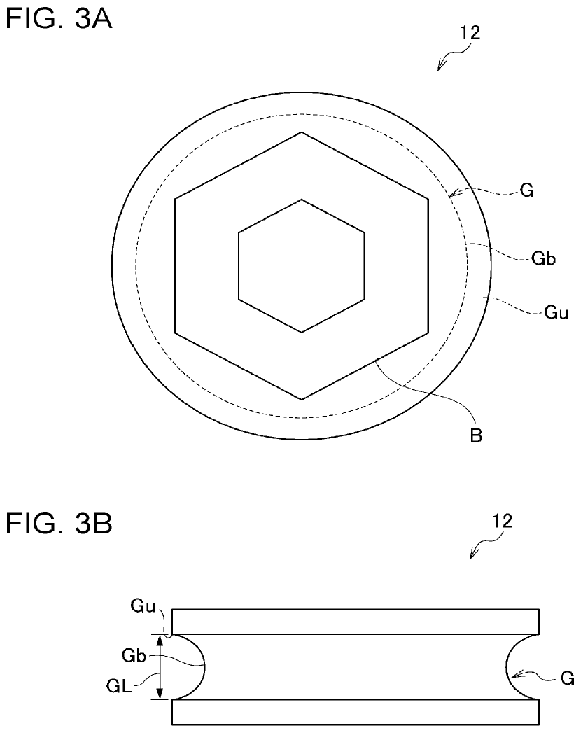

FIG. 3A is a front view of a straightening roller. FIG. 3B is a top view of the straightening roller. In FIG. 3B, an illustration of a bolt B for fixing the straightening roller 12 is omitted. As illustrated in FIG. 3A and FIG. 3B, a groove is formed on the outer circumferential surface of the outer race of the straightening roller 12 in the circumferential direction of the outer race, that is, on the entire circumference in a direction in which the outer race rotates. The groove is referred to below as a straightening groove G.

A sectional shape of the straightening groove G is freely determined, and examples thereof include an arc shape, a U-shape, a rectangular shape, and a V-shape. In an example illustrated, the sectional shape of the straightening groove G is an arc shape. An upper end Gu of the straightening groove G is sufficiently separated upward from a position at which the welding wire W comes into contact with a wall surface of the straightening groove G. An opening width GL of the straightening groove G is preferably slightly larger than the diameter t of the welding wire W. The upper end Gu of the straightening groove G can function as a press member that inhibits the welding wire W from being excessively shifted or vibrated in the straightening groove G in a manner in which the opening width GL of the straightening groove G is slightly larger than the diameter t.

The first roller group 13a and the second roller group 13b will be described with reference to FIG. 2A.

In each of the first and second roller groups 13a and 13b, the multiple straightening rollers 12 include a first roller 12a, a second roller 12b, . . . , and an n-th roller in this order in the direction (the direction from the right to the left in FIG. 2A and FIG. 2B) in which the welding wire W passes through, and the n rollers bend the welding wire W in opposite directions and straighten a curl thereof, where n is an integer of 4 or more. In the example illustrated, n=5 is satisfied. Accordingly, the multiple straightening rollers 12 include the first roller 12a, the second roller 12b, a third roller 12c, a fourth roller 12d, and a fifth roller 12e that are disposed in this order in the direction in which the welding wire W passes through. When the number of the straightening rollers 12 satisfies n=5, the targetability of the welding wire W is stabilized, and the size of the welding-wire-straightening apparatus 1 can be small.

As for the first roller group 13a, the five straightening rollers 12 described above are arranged such that the direction in which the straightening grooves G of the straightening rollers 12 are formed corresponding to the direction in which the straightening rollers 12 rotate partly follows the direction of the straightening path T. The arrangement of the five straightening rollers 12 will now be described.

As for the five straightening rollers 12 of the first roller group 13a, the two straightening rollers 12b and 12d are arranged above the straightening path T illustrated by using the one-dot chain line in upward and downward directions when viewed in front of the paper in FIG. 2A, and the three straightening rollers 12a, 12c, and 12e are arranged below the straightening path T. The two upper straightening rollers 12 are arranged at a predetermined distance 2L between the axes thereof along the straightening path T. Similarly, the three lower straightening rollers 12 are arranged at the predetermined distances 2L between the axes thereof along the straightening path T. The upper straightening rollers 12 and the lower straightening roller 12c face each other in the upward and downward directions that are opposite each other in FIG. 2A with the straightening path T interposed between the straightening grooves G.

As for the five straightening rollers 12 of the first roller group 13a, the straightening rollers 12 that face each other with the straightening path T interposed therebetween do not face in a direction perpendicular to the straightening path T but face each other in oblique directions with respect to the straightening path T. In other words, the two upper straightening rollers, that is, the second roller 12b and the fourth roller 12d face the straightening path T at positions roughly associated with the halves of the distances 2L between the axes of the lower straightening rollers adjacent to each other, that is, the first roller 12a, the third roller 12c, and the fifth roller 12e. In other words, the three lower straightening rollers, that is, the first roller 12a, the third roller 12c, and the fifth roller 12e are arranged such that the two upper straightening rollers, that is, the second roller 12b and the fourth roller 12d face the straightening path T at the positions roughly associated with the halves of the distances 2L between the axes of the straightening rollers adjacent to each other, that is, the first roller 12a, the third roller 12c, and the fifth roller 12e. That is, the arrangement intervals L of the multiple straightening rollers 12 are equal to the halves of the distances 2L between the axes of the upper or lower straightening rollers 12 adjacent to each other. The arrangement intervals L are intervals between the axial centers of the straightening rollers 12a and 12b, of the straightening rollers 12b and 12c, of the straightening rollers 12c and 12d, and of the straightening rollers 12d and 12e in the direction of the straightening path T and may be equal to each other or may differ from each other.

Among the distances 2L between the axes of the five straightening rollers 12 of the first roller group 13a that are adjacent to each other and that will be described in detail later, the distances 2L between the axes of the first roller 12a and the third roller 12c near a wire entrance are especially referred to as 2Lᵢₙ, and the distances 2L between the axes of the fifth roller 12e and the third roller 12c near a wire exit are especially referred to as 2Lₒᵤₜ.

The first roller group 13a that includes the five straightening rollers 12 is supported by the first base 14a as described above. An example of the first base 14a is a member that is composed of the same material as the frame 10 and that has a rectangular cuboid shape and is fixed to the frame 10 with a side surface being in contact with the frame 10. The first base 14a supports the first roller group 13a on a side surface opposite the surface in contact with the frame 10, that is, a support surface A1 that is a side surface parallel with the surface in contact with the frame 10.

Each straightening roller 12 of the first roller group 13a is supported on the support surface A1 by using the bolt B that is screwed in a bolt hole that extends through the inner race and that is formed in the support surface A1 of the first base 14a in advance. In this case, the straightening roller 12 may be supported on the support surface A1 with a spacer S that maintains a constant distance from the support surface A1 interposed between the support surface A1 and the straightening roller 12. In the case where the spacer S is used, the inner race of the straightening roller 12 is interposed between the head of the bolt B that is screwed in the bolt hole in the support surface A1 and the spacer S in contact with the support surface A1, and the straightening roller 12 is supported on the support surface A1 of the first base 14a.

In the case where the spacer S having an appropriate thickness is installed between the first base 14a and the straightening roller 12, and the straightening roller 12 is held, the first base 14a is fixed to the frame 10, and the first roller group 13a can be consequently arranged at the position described above with respect to the straightening path T.

FIG. 2B illustrates the straightening apparatus 1 illustrated in FIG. 2A viewed from above in the front of the paper. As illustrated in FIG. 2B, the straightening rollers 12 of the first roller group 13a are arranged such that the straightening grooves G substantially overlap the straightening path T.

The straightening rollers 12 that are included in the first roller group 13a are fixed at the predetermined positions with respect to the first base 14a, and the first base 14a is fixed at a predetermined position on the frame 10 as described above. The positions at which the straightening rollers 12 that are included in the first roller group 13a are arranged are fixed inside the frame 10. Accordingly, the first roller group 13a does not need to change the positions at which the straightening rollers 12 are arranged inside the frame 10 and can be said as a non-adjustment type.

The second roller group 13b includes the five straightening rollers of the first roller 12a, the second roller 12b, . . . , the fifth roller 12e as in the first roller group 13a and is supported on a support surface A2 of the second base 14b that has substantially the same structure as the first base 14a. That is, the second roller group 13b has substantially the same structure as the first roller group 13a and is said as a non-adjustment type as in the first roller group 13a. The straightening rollers 12 that are included in the second roller group 13b face each other in opposite directions with the straightening path T interposed between the straightening grooves G.

A difference between the second roller group 13b and the first roller group 13a is as follows. The second roller group 13b is arranged such that a direction in which the straightening rollers 12 of the second roller group 13b face each other with the straightening path T interposed therebetween differs from a direction in which the straightening rollers 12 of the first roller group 13a face each other. Specifically, the direction in which the straightening rollers 12 of the second roller group 13b face each other is a direction acquired by rotating, by about 90°, the direction in which the straightening rollers 12 of the first roller group 13a face each other.

For arrangement of the second roller group 13b described above, the second base 14b that supports the second roller group 13b is adjacent to the first roller group 13a and is fixed to the frame 10 such that a side surface adjacent to the support surface A2 on which the second roller group 13b is supported is in contact with the frame 10.

As illustrated in FIG. 2B, the straightening rollers 12 of the second roller group 13b face each other in oblique directions with respect to the straightening path T with the straightening path T interposed therebetween and are arranged such that the straightening grooves G substantially overlap the straightening path T as illustrated in FIG. 2A. That is, as for the first roller group 13a and the second roller group 13b, the straightening rollers 12 are arranged with respect to the straightening path T in substantially the same manner except for a rotation of 90°.

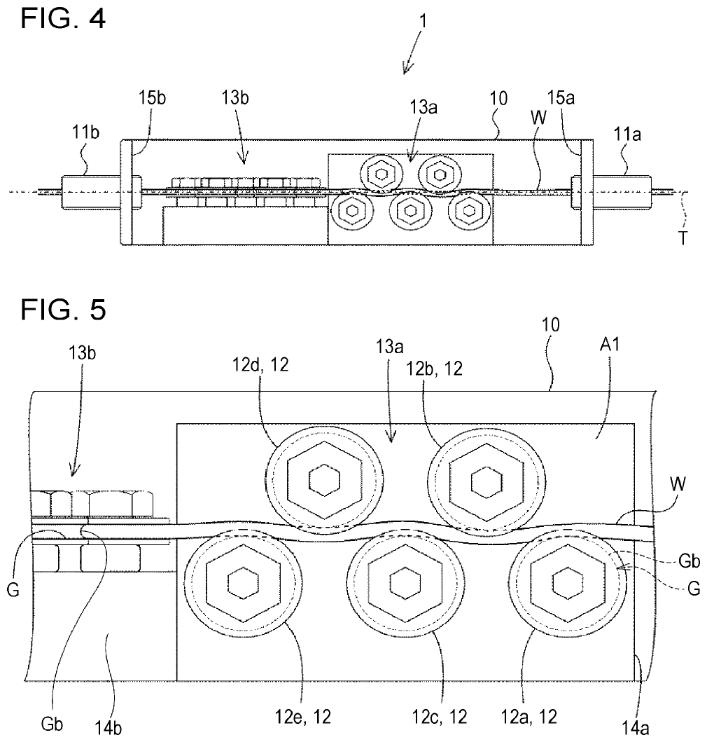

The relationship between the straightening apparatus 1 that includes the first roller group 13a and the second roller group 13b described above and the welding wire W that passes on the straightening path T will be described with reference to FIG. 4 and FIG. 5. FIG. 4 illustrates the welding wire W that passes through the straightening apparatus 1 illustrated in FIG. 2A viewed in front of the straightening apparatus 1. FIG. 5 is an enlarged view of the first roller group 13a of the straightening apparatus 1.

As illustrated in FIG. 4, the welding wire W that passes through the through-hole of the guide pipe 11a from a position outside the frame 10, for example, passes through the first roller group 13a and the second roller group 13b along the straightening path T, passes through the space inside the frame 10 substantially straight toward the guide pipe 11b, and exits toward a position outside the frame 10 via the through-hole of the guide pipe 11b. The welding wire W that passes through the first roller group 13aand the second roller group 13b is pressed by the five straightening rollers 12 of the first roller group 13a and the second roller group 13b alternately in the opposite directions.

Referring to the enlarged view of the first roller group 13a illustrated in FIG. 5, it can be understood that the welding wire W comes into contact with the five straightening rollers 12 of the first roller group 13a in order, is consequently pressed alternately upward and downward when viewed in front of the paper in FIG. 5, and slightly curves upward and downward. At the second roller group 13b, the welding wire W is pressed alternately in directions different by about 90° from the directions in which the welding wire W is pressed by the first roller group 13a, that is, leftward and rightward with respect to the direction in which the welding wire W passes through and slightly curves leftward and rightward.

The welding wire W that thus passes through the first roller group 13a and the second roller group 13b and that curves alternately upward and downward or leftward and rightward is substantially straightened when passing through the second roller group 13b and is pulled out from the straightening apparatus 1.

In the above description of the first roller group 13a and the second roller group 13b, the arrangement of the straightening rollers 12 in the direction of the straightening path T is mainly described. Arrangement in the directions in which the straightening rollers 12 face the straightening path T will now be described in detail.

The structures of the first roller group 13a and the second roller group 13b and the arrangement thereof in the directions in which the straightening rollers 12 face will be described in detail with reference to FIG. 6. FIG. 6 illustrates the concept of a relationship between the arrangement of the straightening rollers 12 in the first roller group 13a and the second roller group 13b and a depth at which the welding wire W is pushed.

As illustrated in FIG. 6, positional relationships in the directions in which the straightening rollers 12 that are included in the first roller group 13a and the second roller group 13b face will be described by using four parameters of the distances 2L between the axes of the straightening rollers 12 adjacent to each other, the diameters 2r of the straightening rollers 12, the diameter t of the welding wire W, and the engaging amounts o of the straightening rollers 12.

The distances 2L between the axes of the straightening rollers 12 adjacent to each other correspond to the distances between the axial centers around which the straightening rollers 12 adjacent to each other rotate. The halves of the distances 2L between the axes are equal to the arrangement intervals L of the straightening rollers 12. The diameters 2r of the straightening rollers 12 are equal to twice the distances from the axial centers of the straightening rollers 12 to the groove bottoms Gb of the straightening grooves G. Accordingly, the distances from the axial centers of the straightening rollers 12 to the groove bottoms Gb are equal to a roller radius r.

According to the present embodiment, the diameter 2r of each straightening roller 12 is preferably 20 mm or less, more preferably 18 mm or less, further preferably 16 mm or less. The use of the straightening roller 12 the diameter 2r of which is 20 mm or less, which is a small diameter, enables the size of the entire straightening apparatus 1 to decrease. In contrast, in the case where the diameter 2r of the straightening roller 12 is more than 20 mm, the welding wire W does not appropriately deform, and the size of the welding-wire-straightening apparatus 1 increases. As the diameter 2r of the straightening roller 12 decreases, a bearing diameter needs to be decrease. However, the rated load of a bearing having a small diameter is low, and there is a possibility that the lifespan of the bearing decreases, or a rotation failure occurs due to an excessive load. Accordingly, the diameter 2r of the straightening roller 12 is preferably 10 mm or more, more preferably 11 mm or more, further preferably 12 mm or more.

The diameter t of the welding wire W is the wire diameter of the welding wire W, and it is thought that the diameter t is, for example, no less than 1.2 mm and no more than 1.6 mm. However, the diameter t is not limited to the numeric range described above but is freely determined.

As illustrated in FIG. 6, the engaging amounts o of the straightening rollers 12 represent the degree at which the straightening rollers 12 overlap when the groove bottoms Gb of two straightening rollers 12 that face each other with the straightening path T described above interposed therebetween are viewed in the direction of the straightening path T. The groove bottoms Gb of the two straightening rollers 12 overlap so as to be inserted in the straightening path T when viewed in the direction of the straightening path T. It can be said that the straightening rollers 12 are engaged at the degree of overlapping, and the degree at which the straightening rollers 12 overlap is referred to as the engaging amounts δ of the straightening rollers 12.

In this case, the engaging amounts δ have a positive value when the groove bottoms Gb of the two straightening rollers 12 that face each other overlap so as to be inserted in the straightening path T and have the value of 0 (zero) when the groove bottoms Gb of the two straightening rollers 12 that face each other are on a single line substantially parallel with the straightening path T. When the groove bottoms Gb of the two straightening rollers 12 that face each other are not on a single line substantially parallel with the straightening path T and do not overlap in the above manner, the groove bottoms Gb of the two straightening rollers 12 are separated from the single line and are spaced from each other, and the engaging amounts δ have a negative value depending on a distance corresponding to the length of the space.

For the above reason, as illustrated in FIG. 6, the depth (δ+t) at which the welding wire W is pushed by each straightening roller 12 is equal to the sum of the engaging amount δ and the diameter t.

As for the first and second roller groups 13a and 13b, the multiple straightening rollers 12 are arranged in advance such that a wire deformation amount ε is within a predetermined range, and the positions thereof are fixed. According to the present embodiment, no screws for adjusting the positions of the straightening rollers are provided accordingly.

A method of calculating the wire deformation amount & according to the present embodiment will be described with reference to FIG. 6. The wire deformation amount ε can be calculated based on three rollers that are continuous in the direction in which the wire passes through such as the first roller 12a, the second roller 12b, and the third roller 12c. The wire deformation amount ε (%) due to the three continuous rollers can be calculated by using an expression (1) expressed as:

ε={2t(δ+t)/L²}×100. . . . (1)

As for the straightening apparatus 1, a welding-wire-entrance wire deformation amount εᵢₙ is calculated based on the expression (1) described above from the positional relationships among the first roller 12a, the second roller 12b, and the third roller 12c. That is, the entrance wire deformation amount εᵢₙ can be calculated by using an expression of εᵢₙ={2t (δᵢₙ+t)/Lᵢₙ²}×100, where t (mm) is the diameter of the welding wire W, εᵢₙ (%) is the entrance wire deformation amount due to the first roller 12a, the second roller 12b, and the third roller 12c, δᵢₙ (mm) is an entrance roller engaging amount, and 2Lᵢₙ (mm) is the distance between the axes of the first roller 12a and the third roller 12c.

As for the straightening apparatus 1, a welding-wire-exit wire deformation amount εₒᵤₜ is calculated based on the expression (1) described above from the positional relationships among the third roller 12c, the fourth roller 12d, and the fifth roller 12e. That is, the exit wire deformation amount εₒᵤₜ can be calculated by using an expression of εₒᵤₜ={2t (δₒᵤₜ+t)/Lₒᵤₜ²}×100, where εₒᵤₜ (%) is the exit wire deformation amount due to the third roller 12c, the fourth roller 12d, and the fifth roller 12e, δₒᵤₜ (mm) is an exit roller engaging amount, and 2Lₒᵤₜ (mm) is the distance between the axes of the fifth roller 12e and the third roller 12c.

The lower limit of the entrance wire deformation amount εᵢₙ is preferably 0.6%, and the upper limit thereof is preferably 1.0%, and the lower limit is more preferably 0.7%, and the upper limit is more preferably 0.9%. The lower limit of the exit wire deformation amount εₒᵤₜ is preferably 0.0%, and the upper limit thereof is preferably 0.3%. When the entrance wire deformation amount εᵢₙ and the exit wire deformation amount εₒᵤₜ do not satisfy the above ranges of 0.6≤εᵢₙ≤1.0, and 0.0≤εₒᵤₜ≤0.3, the effect of straightening the welding wire W that has a curl reduces because the amount of deformation of the welding wire W is insufficient in the case of less than the lower limits, or because the welding wire W excessively deforms in the case of more than the upper limits, the wire misalignment of an end portion of the welding wire W occurs during welding, the targetability is degraded, and the quality of welding becomes unstable.

According to the present embodiment, depths δᵢₙ+t and δₒᵤₜ+t at which the wire is pushed by the straightening rollers 12, distances 2Lᵢₙ and 2Lₒᵤₜ between the axes of the straightening rollers 12 adjacent to each other, and the diameters 2r of the straightening rollers 12, for example, are determined such that the entrance wire deformation amount εᵢₙ and the exit wire deformation amount εₒᵤₜ are within the above ranges, and the positions of the straightening rollers 12 are fixed in advance. Accordingly, the use of the straightening apparatus 1 to straighten the curl of the welding wire W inhibits wire misalignment from occurring and enables the targetability of the welding wire W to be improved while welding is performed by using the straightened welding wire W and also enables the quality of welding to be good. In addition, it is not necessary to adjust the positions of the straightening rollers 12 by using, for example, screws for adjusting the positions, and the effect of straightening can be always stable and good.

In the example illustrated, the number of the straightening rollers 12 of the roller groups 13a and 13b satisfies n=5. According to the present invention, however, the number of the straightening rollers 12 can be freely set to 4 or more. In a typical example, when the straightening apparatus includes the n rollers, the entrance wire deformation amount εᵢₙ can be calculated by using, for example, the positional relationships among the first roller 12a, the second roller 12b, and the third roller 12c. The exit wire deformation amount εₒᵤₜ can be calculated by using, for example, the positional relationships among the (n−2) -th roller, the (n−1) -th roller, and the n-th roller.

According to the present embodiment, the arrangement intervals L of the multiple straightening rollers 12 are preferably 11.5 mm or more, more preferably 12 mm or more, further preferably 12.5 mm or more. The present inventors have found that in the case where the diameters 2r of the straightening rollers 12 according to the present embodiment are small diameters of 20 mm or less as described above, areas J at which the straightening rollers 12 and the welding wire W come into contact with each other decrease, and that a local load is applied to the welding wire W in some cases. According to the present embodiment, the arrangement intervals L of the multiple straightening rollers 12 are set to 11.5 mm or more in order to inhibit such a local load from being applied.

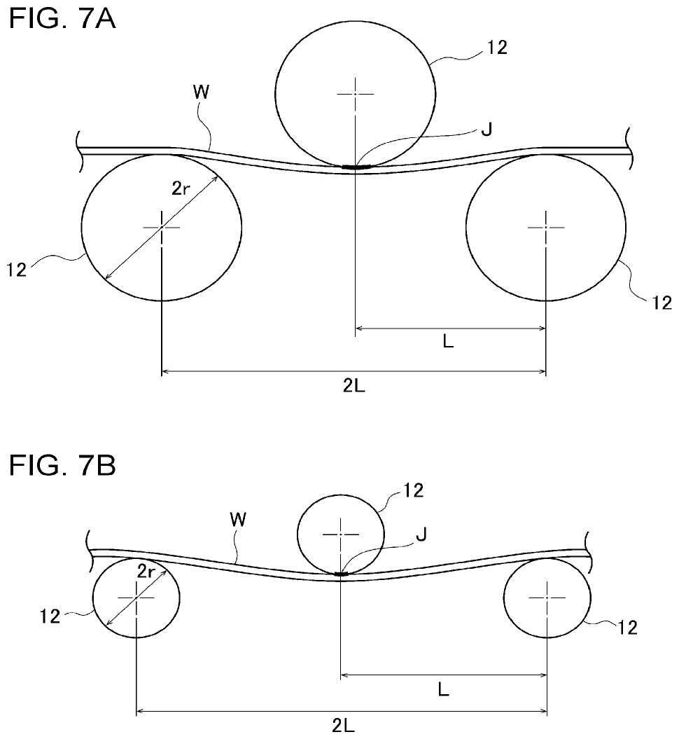

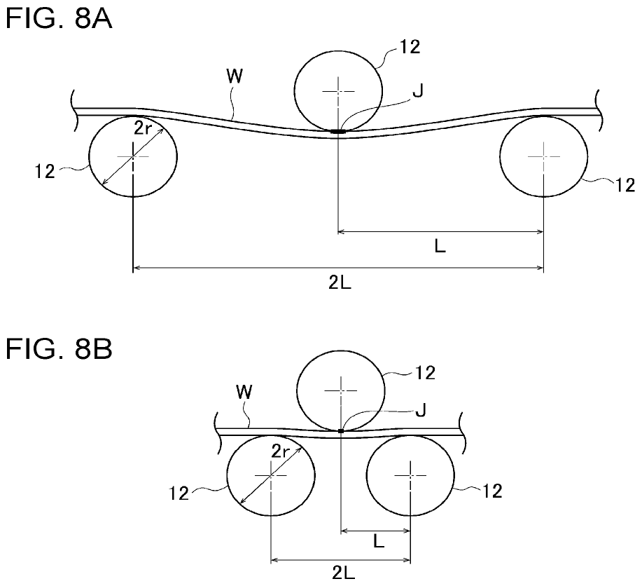

Relationships among the diameters 2r of the straightening rollers, the arrangement intervals L, and the areas J at which the straightening rollers 12 and the welding wire W come into contact with each other will be described with reference to FIG. 7A to FIG. 8B. FIG. 7A illustrates the concept of a relationship between the straightening rollers 12 and the welding wire W in the case where the diameters 2r of the straightening rollers 12 are relatively large, for example, more than 20 mm. FIG. 7B illustrates the concept of a relationship between the straightening rollers 12 and the welding wire W in the case where the diameters 2r of the straightening rollers 12 are smaller than those in FIG. 7A, for example, 20 mm or less. FIG. 8A illustrates the concept of a relationship between the straightening rollers 12 and the welding wire W in the case where the arrangement intervals L of the straightening rollers 12 are relatively large, for example, 11.5 mm or more. FIG. 8B illustrates the concept of a relationship between the straightening rollers 12 and the welding wire W in the case where the arrangement intervals L of the straightening rollers 12 are shorter than those in FIG. 8A, for example, less than 11.5 mm.

As illustrated in FIG. 8B, in the case where the diameters 2r of the straightening rollers 12 are smaller than those in FIG. 8A, the areas J at which the straightening rollers 12 and the welding wire W come into contact with each other decrease. As illustrated in FIG. 8B, in the case where the arrangement intervals L of the straightening rollers 12 are shorter than those in FIG. 8A, the areas J at which the straightening rollers 12 and the welding wire W come into contact with each other decrease. That is, in the case where the straightening rollers 12 have small diameters, or in the case where the arrangement intervals L of the straightening rollers 12 are short, the areas J decrease, and a local load is consequently applied to the welding wire W. The welding wire W deforms, and the targetability is degraded. The inventors have found that this is conspicuous in the case where the welding wire W is a flux containing wire, that deformation is likely to occur particularly when the weight ratio of the flux filled therein is high, and the flux containing wire has a thin outer skin, and that the targetability is greatly affected.

In view of this, according to the present embodiment, the arrangement intervals L are 11.5 mm or more in order to prevent the welding wire W from deforming and maintain good targetability even when the diameters 2r of the straightening rollers 12 are small diameters of 20 mm or less.

The arrangement intervals L of the straightening rollers 12 are preferably 16 mm or less, more preferably 14 mm or less, further preferably 12 mm or less. In the case where the arrangement intervals L are more than 16 mm, the welding wire W cannot be appropriately deformed, the effect of straightening the curl of the welding wire W reduces even when the wire deformation amounts εᵢₙ and εₒᵤₜ satisfy the ranges according to the present invention, and the size of the welding-wire-straightening apparatus 1 increases.

As for the first and second roller groups 13a and 13b, the distance Lₐₗₗ between the axes of the first roller 12a that is nearest to the entrance and the fifth roller 12e that is nearest to the exit is preferably 70 mm or less, more preferably 65 mm or less, further preferably 60 mm or less. The distance Lₐₗₗ between the axes can be expressed as a relational expression of Lₐₗₗ=L×(n−1) where L is the arrangement intervals, and n is the number of the straightening rollers 12 that are included in the roller groups 13a and 13b. That is, in the example illustrated, n=5 is satisfied, and Lₐₗₗ=4L is satisfied. When the distance Lₐₗₗ between the axes is 70 mm or less, the size of the straightening apparatus 1 can be decreased.

In the example illustrated, the number of the straightening rollers 12 satisfies n=5. Also, in the case where the number of the straightening rollers 12 is changed, the distance Lₐₗₗ between the axes of the first roller 12a that is nearest to the entrance and the n-th roller that is nearest to the exit is preferably 70 mm or less.

The full length M of the straightening apparatus 1 is preferably 220 mm or less, more preferably 210 mm or less, further preferably 200 mm or less. The full length M of the straightening apparatus 1 corresponds to the length of the straightening apparatus 1 in the direction in which the welding wire W passes through with the pair of the guide pipes 11a and 11b removed and to a distance between the entrance side of the wall plate 15a and the exit side of the wall plate 15b. The full length M is thus 220 mm or less, and the size thereof is small. Accordingly, the straightening apparatus 1 is unlikely to be restricted due to the size and shape of the space for installation, and the range of movement of the welding robot 2 can be increased in the case where the straightening apparatus 1 is disposed at a position on the robot arm such as the position P1 (see FIG. 1).

The first roller group 13a and the second roller group 13b described according to the present embodiment have the same structure and the same conditional parameters. However, the effects of the present invention are exerted even when the first roller group 13a and the second roller group 13b have different structures and different conditions within the ranges according to the present invention. For example, the first roller group 13a and the second roller group 13b may differ provided that the entrance wire deformation amount εᵢₙ ranges from 0.6 to 1.0 (%), may differ provided that the exit wire deformation amount εₒᵤₜ ranges from 0.0 to 0.3 (%), may have different numbers of the straightening rollers 12, may differ provided that the diameters 2r of the straightening rollers 12 are 20 mm or less, may differ provided that the arrangement intervals L of the multiple straightening rollers 12 are 11.5 mm or more, and may have different other parameters or structures.

### EXAMPLES

The results of tests in the case where the welding wire W is straightened by using welding-wire-straightening apparatuses 1 in examples and comparison with that in comparative examples will now be described.

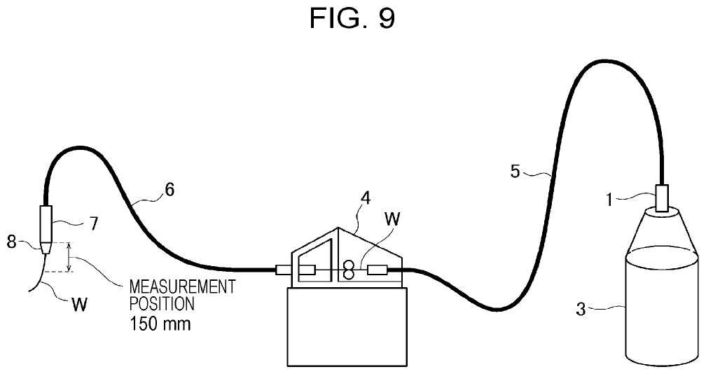

FIG. 9 schematically illustrates a targetability test apparatus. As for the targetability test apparatus, as illustrated in FIG. 9, each straightening apparatus 1 is mounted on the pack 3 that contains the welding wire W. An end portion of a conduit cable 5 is connected to the exit of the straightening apparatus 1, and another end portion thereof is connected to the feeding device 4. Accordingly, the welding wire W passes through an inner space of the conduit cable 5 via the straightening apparatus 1 and is inserted in the feeding device 4. A welding torch 7 is connected to the exit of the feeding device 4 with a conduit cable 6 interposed therebetween. A contact chip 8 (referred to below as a chip 8) is disposed at an end of the welding torch 7.

As for the targetability test apparatus that has such a structure, the feeding device 4 is driven, the welding wire W that is pulled out from the pack 3 consequently passes through the inner space of each straightening apparatus 1, and the curl of the welding wire W is straightened. Subsequently, the wire W advances in the inner space of the conduit cable 5 and is fed to the chip 8 of the welding torch 7 via the feeding device 4.

The coordinates of the welding wire W in an X direction and a Y direction were measured at a position 150 mm away from an end of the chip 8 with the welding wire W that was fed from the chip 8 protruding from the end of the chip 8, and the straightness of the welding wire W was tested. The X direction and the Y direction were perpendicular to the upward and downward directions in which the chip 8 extended in FIG. 9. The number of times the XY coordinates were measured was 100 times or more. The welding wire W was cut at the exit of the chip 8 whenever measurement was made.

As for all of the straightening apparatuses 1 that were used in the examples and the comparative examples, the straightening rollers 12 were arranged at the same interval L, and the straightening rollers 12 of the first roller group 13a and the second roller group 13b were arranged and fixed in the same manner to the first base 14a and the second base 14b having the same shape.

In Table 1 described below, test conditions in first to fourth examples and first to fourth comparative examples are illustrated.

TABLE 1

| | | | | | Straightening | | | | |
|---|---|---|---|---|---|---|---|---|---|
| | | | | Straightening | roller | | | Straightening | Distance |
| | | | | roller | arrangement | Deformation | | apparatus | between |
| | | Straightening | Welding | diameter | interval | amount [%] | | full length | axes |
| | | apparatus | wire | 2r [mm] | L [mm] | εᵢₙ | εₒᵤₜ | M [mm] | Lₐₗₗ [mm] |
| Examples | 1 | A | a | 14 | 12.5 | 0.75 | 0.15 | 176 | 50 |
| | 2 | B | b | 14 | 12.5 | 0.86 | 0.18 | 176 | 50 |
| | 3 | C | c | 14 | 12.5 | 0.88 | 0.20 | 176 | 50 |
| | 4 | C | d | 14 | 12.5 | 0.88 | 0.20 | 176 | 50 |
| Comparative | 1 | None | d | — | — | — | — | — | — |
| examples | 2 | D | c | 14 | 11.0 | 0.90 | 0.21 | 176 | 44 |
| | 3 | D | d | 14 | 11.0 | 0.90 | 0.21 | 176 | 44 |
| | 4 | E | d | 21 | 18.0 | 0.89 | 0.20 | 250 | 72 |

In targetability tests, the straightening apparatuses 1 of five kinds of A to E were used. As for each of the straightening apparatuses 1 of the five kinds of A to E, the positions of the multiple straightening rollers 12 were adjusted such that the diameters 2r of the straightening rollers 12, the arrangement intervals L of the straightening rollers 12, the entrance wire deformation amount εᵢₙ, the exit wire deformation amount εₒᵤₜ, the full length M of the straightening apparatus 1, and the distance Lₐₗₗ between the axes of the first roller 12a and the fifth roller 12e had various values.

Welding wires W of four kinds of a to d, the diameters 2r of which were 1.2 to 1.6 mm were used. The welding wires W of the kinds of a to d were flux containing wires.

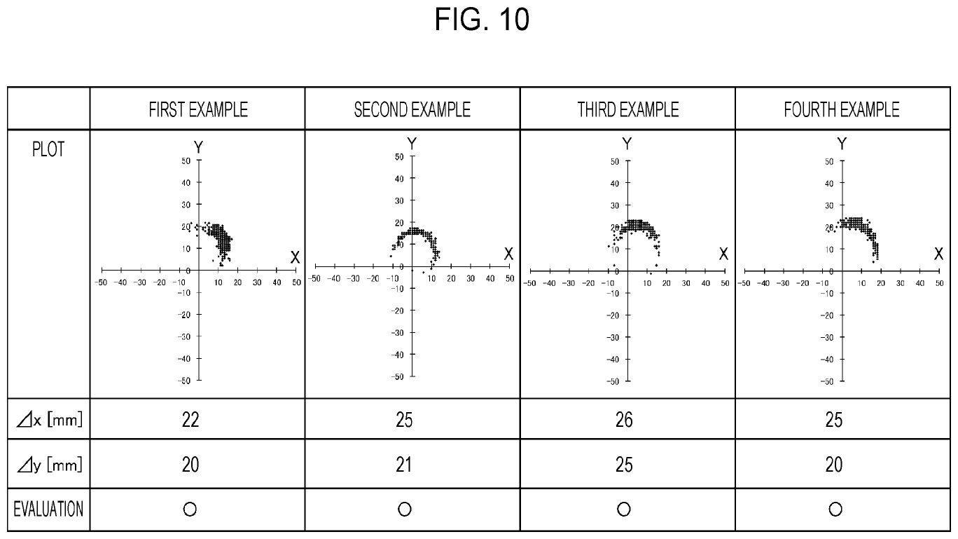

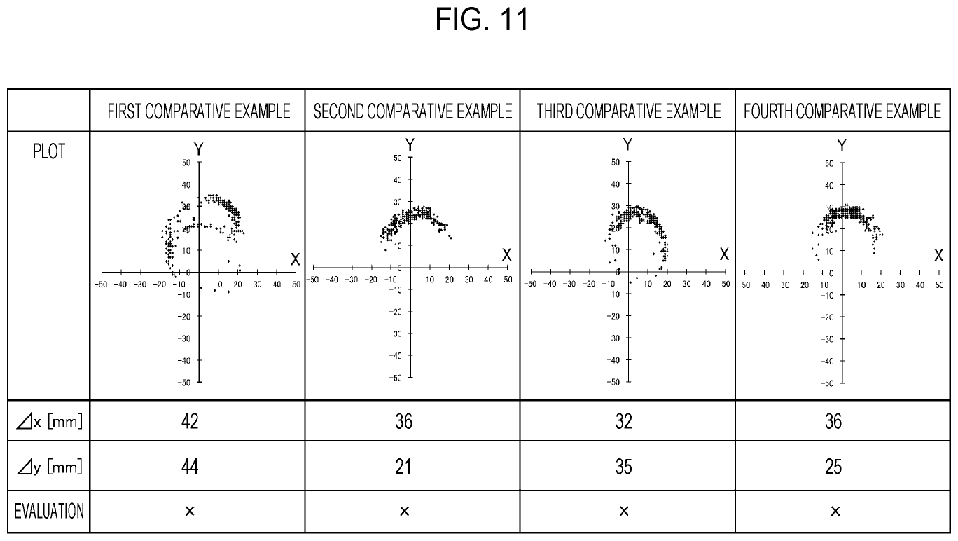

FIG. 10 illustrates the results of the tests in the first to fourth examples. FIG. 11 illustrates the results of the tests in the first to fourth comparative examples. In FIG. 10 and FIG. 11, the XY coordinates of the welding wires W are plotted. Whether the targetability of the welding wires W is good is determined such that the targetability is good (illustrated by using a “circle in EVALUATION” in FIG. 10) in the case where Δx (mm) and Δy (mm) are 30 mm or less, that is, Δx≤30 and Δy≤30 are satisfied in plots, where Δx (mm) is a difference between the maximum value and the minimum value in the X direction, and Δy (mm) is a difference between the maximum value and the minimum value in the Y direction and such that the targetability is not good (illustrated by using a “cross in EVALUATION” in FIG. 11) in the other cases.

In the first to fourth examples, the diameters 2r of the straightening rollers 12, the arrangement intervals L, the entrance wire deformation amount εᵢₙ and the exit wire deformation amount εₒᵤₜ were within the preferable ranges of {2r≤20 (mm), L≥11.5 (mm), 0.6≤εᵢₙ≤1.0 (%), and 0.0≤εₒᵤₜ≤0.3 (%) } described above. The full length M of the straightening apparatus 1 was 200 mm or less, the distance Lₐₗₗ between the axes was 60 mm or less, and accordingly, the size of each apparatus decreased. In the first to fourth examples, Δx≤30 and Δy≤30 were satisfied, and the targetability of the welding wires W was good.

In the first comparative example, the straightening apparatuses 1 were not used, and the curl of the welding wire W was not straightened. Accordingly, the values of Δx and Δy were large values of more than 40, and the targetability of the welding wire W was poor.

In the second and third comparative examples, the arrangement intervals L (the distance Lₐₗₗ between the axes) of the straightening rollers 12 differed from those in the first to fourth examples, and the arrangement intervals L were set to 11 mm. That is, in the second and third comparative examples, the diameters 2r of the straightening rollers 12 were within the preferable range of {2r≤20 (mm)}, but the arrangement intervals L were out of the preferable range of L≥11.5 (mm) described above. In the second comparative example, the value of Δy was 21 mm, but the value of Δx was a large value of 36 mm. In the third comparative example, the values of Δx and Δy were more than 30 mm. In the second and third comparative examples in which the arrangement intervals L were less than 11.5 mm, the targetability of the welding wires W was poor. The reason is presumably that the diameters 2r of the straightening rollers 12 and the arrangement intervals L were small, and the areas J at which the straightening rollers 12 and the welding wires W came into contact with each other consequently decreased, a local load was applied to the welding wires W, and the welding wires W deformed as described above with reference to FIG. 7A to FIG. 8B.

In the fourth comparative example, the entrance wire deformation amount εᵢₙ and the exit wire deformation amount εₒᵤₜ did not greatly differ from those in the first to fourth examples and the second and third comparative examples, but the diameters 2r of the straightening rollers 12, the arrangement intervals L, the distance Lₐₗₗ between the axes, and the full length M of the straightening apparatus were large, and the straightening apparatus that was used was relatively large. In the fourth comparative example, the value of Δy was 25 mm, but the value of Δx was a large value of 36 mm, and the targetability of the welding wire W was poor. The reason is presumably that L>16 mm was satisfied, and the welding wire W consequently did not appropriately deform.

It is to be thought that the embodiment is disclosed herein by way of example in all aspects and is not restrictive. In particular, matters that are not explicitly disclosed according to the embodiment such as operational conditions, measurement conditions, various parameters, and the dimensions, the weight, and the volume of a structure are not deviated from ranges for typical implementation by a person skilled in the art, and values that can be readily presumed by a person skilled in the art are used.

For example, the first roller group 13a is arranged by using the first base 14a, and the second roller group 13b is arranged by using the second base 14b. However, even when the first base 14a is not used for the first roller group 13a, the first roller group 13a can be arranged at the position described above with respect to the straightening path T, for example, in a manner in which the bolts B are directly screwed into the bolt holes of the frame 10, provided that the bolt holes are formed in the frame 10 and that the lengths of the spacers S are sufficiently increased.

Matters described below are disclosed in the present specification as described above.
(1) A welding-wire-straightening apparatus includes two sets of roller groups each of which includes multiple straightening rollers. A welding wire that bends is straightened by causing the welding wire to pass through the two sets of roller groups. The multiple straightening rollers that are included in the two sets of roller groups are arranged at a predetermined arrangement interval L in a direction in which the welding wire passes through such that a straightening path through which the welding wire passes is interposed therebetween. The two sets of roller groups are arranged such that directions in which the straightening path is interposed differ from each other. In each of the two sets of roller groups, the multiple straightening rollers include a first roller, a second roller, . . . , an n-th roller in this order in the direction in which the welding wire passes through, and the n rollers (n is an integer of 4 or more) bend the welding wire alternately in opposite directions and straighten a curl of the welding wire. The n rollers of the multiple straightening rollers are arranged such that an entrance wire deformation amount εᵢₙ that is calculated by using a numerical formula of εᵢₙ={2t(δᵢₙ+t)/Lᵢₙ²}×100 ranges from 0.6 to 1.0 (%), and an exit wire deformation amount εₒᵤₜ that is calculated by using a numerical formula of εₒᵤₜ=2t(δₒᵤₜ+t)/Lₒᵤₜ²}×100 ranges from 0.0 to 0.3 (%), where t (mm) is a diameter of the welding wire, εᵢₙ (%) is the entrance wire deformation amount due to the first roller, the second roller, and a third roller, δᵢₙ (mm) is an entrance roller engaging amount, 2Lᵢₙ (mm) is a distance between axes of the first roller and the third roller, εₒᵤₜ (%) is the exit wire deformation amount due to a (n−2)-th roller, a (n−1)-th roller, and the n-th roller, δₒᵤₜ (mm) is an exit roller engaging amount, and 2Lₒᵤₜ (mm) is a distance between axes of the n-th roller and the (n−2)-th roller. Diameters 2r of the multiple straightening rollers are 20 mm or less. The arrangement interval L of the multiple straightening rollers is 11.5 mm or more.

Based on (1) where the entrance wire deformation amount εᵢₙ and the exit wire deformation amount εₒᵤₜ are set to amounts within the ranges (0.6≤εᵢₙ≤1.0, and 0.0≤εₒᵤₜ≤0.3) described above, the effect of straightening the welding wire W that has the curl is improved, the targetability of the welding wire W is good, and the quality of welding is stabilized. In addition, the use of the straightening rollers 12 the diameters 2r of which are 20 mm or less enables the size of the straightening apparatus 1 to be decreased as a whole. In the case where the straightening rollers 12 the diameters 2r of which are 20 mm or less are used, the areas J at which the straightening rollers 12 and the welding wire W come into contact with each other decrease, and a local load is applied to the welding wire W in some cases. However, the arrangement intervals L of the multiple straightening rollers 12 are set to values of 11.5 mm or more, the areas J increase accordingly, a local load is inhibited from being applied to the welding wire W, the welding wire W is prevented from deforming, and good targetability can be maintained.
(2) As for the welding-wire-straightening apparatus described in (1), the welding wire is a flux containing wire. Based on (2), the flux containing wire is inhibited from deforming due to a local load that is applied thereto, and good targetability can be maintained, even when the flux containing wire has hardness, rigidity, and tensile strength that differs from those of a solid wire and is likely to deform.
(3) As for the welding-wire-straightening apparatus described in (1) or (2), the diameters 2r of the straightening rollers are 10 mm or more. In the case where the straightening rollers include, for example, bearings, it is necessary to decrease the diameters of the bearings as the diameters 2r of the straightening rollers decrease. However, the rated load of a bearing having a small diameter is low, and there is a possibility that the lifespan of the bearing decreases, or a rotation failure occurs due to an excessive load. Accordingly, these problems can be reduced based on (3).
(4) As for the welding-wire-straightening apparatus described in any one of (1) to (3), the arrangement intervals L of the multiple straightening rollers are 16 mm or less. Based on (4), both of the effect of straightening the curl of the welding wire W and the effect of decreasing the size of the straightening apparatus can be exerted. In contrast, when the arrangement intervals L are more than 16 mm, the welding wire W cannot be appropriately deformed, the effect of straightening the curl of the welding wire W reduces, and the size of the straightening apparatus 1 increases even when the wire deformation amounts εᵢₙ and εₒᵤₜ are within the ranges according to the present invention.
(5) As for the welding-wire-straightening apparatus described in any one of (1) to (4), the distance Lₐₗₗ between the axes of the first roller and the n-th roller is 70 mm or less. Based on (5), the size of the straightening apparatus 1 can be decreased.
(6) As for the welding-wire-straightening apparatus described in any one of (1) to (5), n=5 is satisfied. Based on (6), the targetability of the welding wire W is stabilized, and the size of the welding-wire-straightening apparatus 1 can be decreased.

What is claimed is:

1. A welding-wire-straightening apparatus comprising:
two sets of roller groups each of which includes multiple straightening rollers,
wherein a welding wire that bends is straightened by causing the welding wire to pass through the two sets of roller groups,
wherein the multiple straightening rollers that are included in the two sets of roller groups are arranged at a predetermined arrangement interval L in a direction in which the welding wire passes through such that a straightening path through which the welding wire passes is interposed therebetween,
wherein the two sets of roller groups are arranged such that directions in which the straightening path is interposed differ from each other,
wherein, in each of the two sets of roller groups, the multiple straightening rollers include a first roller, a second roller, . . . , an n-th roller in this order in the direction in which the welding wire passes through, and the n rollers (n is an integer of 4 or more) bend the welding wire alternately in opposite directions and straighten a curl of the welding wire,
wherein the n rollers of the multiple straightening rollers are arranged such that an entrance wire deformation amount εᵢₙ that is calculated by using a numerical formula of εᵢₙ={2t(δᵢₙ+t)/Lᵢₙ²}×100 ranges from 0.6 to 1.0 (%), and an exit wire deformation amount εₒᵤₜ that is calculated by using a numerical formula of εₒᵤₜ=2t(δₒᵤₜ+t)/Lₒᵤₜ²}×100 ranges from 0.0 to 0.3 (%), where t (mm) is a diameter of the welding wire, εᵢₙ (%) is the entrance wire deformation amount due to the first roller, the second roller, and a third roller, δᵢₙ (mm) is an entrance roller engaging amount, 2Lᵢₙ (mm) is a distance between axes of the first roller and the third roller, εₒᵤₜ (%) is the exit wire deformation amount due to a (n−2)-th roller, a (n−1)-th roller, and the n-th roller, δₒᵤₜ (mm) is an exit roller engaging amount, and 2Lₒᵤₜ (mm) is a distance between axes of the n-th roller and the (n−2)-th roller,
wherein diameters 2r of the multiple straightening rollers are 20 mm or less, and
wherein the arrangement interval L of the multiple straightening rollers is 11.5 mm or more.

2. The welding-wire-straightening apparatus according to claim 1,
wherein the welding wire is a flux containing wire.

3. The welding-wire-straightening apparatus according to claim 1,
wherein the diameters 2r of the straightening rollers are 10 mm or more.

4. The welding-wire-straightening apparatus according to claim 1,
wherein the arrangement interval L of the multiple straightening rollers is 16 mm or less.

5. The welding-wire-straightening apparatus according to claim 1,
wherein a distance Lₐₗₗ between axes of the first roller and the n-th roller is 70 mm or less.

6. The welding-wire-straightening apparatus according to claim 1,
wherein n=5 is satisfied.
